(19) United States
(12) Patent Application Publication
(10) Pub. No.: US 2004/0088244 A1
(43) Pub. Date: May 6, 2004

(54) System and method for accommodating rated transactions in an electronic commerce system

(76) Inventors: William Dale Bartter, Gahanna, OH (US); Yigang Cai, Naperville, IL (US); Mark Raymond Locher, Dublin, OH (US); Brian Robertson Rae, Bristol (GB); Allan Terry Rush, Glendale, AZ (US); Sridhar Sripathi, Columbus, OH (US)

Correspondence Address: Docket Administrator (Room 3J-219), Lucent Technologies Inc., 101 Crawfords Corner Road, Holmdel, NJ, 07733-3030, US

(21) Appl. No.: 10/284,843

(22) Filed: Oct. 31, 2002

(51) Int. Cl. G06F 17/60

(52) U.S. Cl. 705/38

(57) ABSTRACT

An intelligent network-based e-commerce system 100 computes costs and bills customers for rated transactions based on service type and/or content. A gateway device such as a gateway server 104 or short message service center (SMSC) 404 receives costing/billing requests (or “rated debit requests”) and forwards the requests to one or more service control points (SCPs) 122. The SCPs maintain subscriber accounts for one or more subscribers and maintain a tariff table having cost/rate information associated with one or more services. Upon receiving the costing/billing request, an SCP consults the tariff table to determine the cost/rate information corresponding to the service type and/or content identified in the rated debit request and computes the cost of the service based on the rate information. In one embodiment, the SCP further determines an eligibility of the subscriber account to be billed for the service (i.e., authorization for the service, sufficiency of account balance and allowance of overcharges) and, in response to a positive determination of eligibility, debits the cost of the service from the subscriber account.

### FIELD OF THE INVENTION

This invention relates generally to the field of electronic commerce (or “e-commerce) and, more particularly, to an intelligent network-based e-commerce system that incorporates a gateway server.

### CROSS REFERENCE TO RELATED APPLICATIONS

This application is related to the following applications filed concurrently with the present application, assigned to the assignee of the present invention and incorporated herein by reference in their entirety: Bartter 1-20-2-1-1-1 and Bartter 221-3-2-2-2.

### BACKGROUND OF THE INVENTION

Communication networks such as the Internet are known to interconnect communication devices spanning a large geographical area. Generally, the Internet (sometimes referred to as the World Wide Web) is a combination of local area networks (LANs) and wide area networks (WANs) that speak the same protocols (e.g., TCP/IP protocol), thereby allowing a variety of communication devices connected to the Internet to communicate with each other. For example, communication devices including without limitation, computers, cell phones, wireline phones, pagers, two-way radios, personal digital assistants (PDAs) and the like may be connected to the network, using access technologies such as Ethernet, telephone wires, base radios, satellites or Asynchronous Transfer Mode (ATM) networks.

As is well known, users of communication devices connected to the Internet may surf through a variety of web sites hosted by business enterprises, government entities, educational institutions and the like. Often, such sites offer goods or services for sale that may be purchased electronically by the Internet user (i.e., by performing point-and-click, keystrokes, and the like via the user device). The electronic purchase of goods or services is known as electronic commerce, or c-commerce. As presently known, e-commerce systems offer conventional “postpaid” services where a customer orders goods or services, typically using a credit card, and pays the credit card company some time later. Most commonly, the goods or service have a specific price that is known to both the customer and merchant.

Related application Bartter 1-20-2-1-1-1, titled “Network-Based Electronic Commerce System Incorporating Prepaid Service Offerings” describes another type of e-commerce system offering “prepaid” service where customers pay up front for a certain level of goods or services and, as long as sufficient balance is present in their account, may perform e-commerce transactions without the need for credit cards or contracts and without receiving monthly bills. Prepaid services offerings are known for voice telecommunications but to date have not been available for e-commerce transactions.

A problem that arises is that certain types of services, most particularly network-based services such as Internet charges, file uploads/downloads, wireless service charges and the like may not have specific, predefined charges. For example, service providers may wish to charge for certain services based on service type and/or content type, number and/or size of messages, periodic type and subscription charges and the like which generally result in different charges for each transaction even among transactions of the same service type or rate. It would be desirable for an e-commerce system to compute costs and bill customers for such rated transactions, thus relieving service providers from such burden and allowing them to focus on providing the requested service(s). Advantageously, in a prepaid e-commerce system, the system will inform service providers whether sufficient balance exists in the subscriber accounts to pay for the services.

### SUMMARY OF THE INVENTION

The present invention provides methods for accommodating rated transactions, including costing and billing subscriber accounts, in an intelligent network-based e-commerce system.

In one embodiment, the e-commerce system receives a rated debit request from a service provider. The rated debit request includes an identifier of a subscriber to be charged for a service, and indicia of at least one of a service type and content associated with the service. The system identifies a subscriber account and associated account balance, determines a cost of the service based on the service type and/or content and determines an eligibility of the subscriber account to be billed for the service. If the subscriber account is eligible to be billed for the service, the system debits the cost of the service from the account balance and sends an acknowledgment message to the service provider.

In one embodiment, the rated debit request is received by a gateway device operably coupled to one or more service control points (SCPs). The gateway device may comprise, for example, a gateway server or short message service center (SMSC). Upon receiving the rated debit request, the gateway device sends a message to an SCP including billing information comprising a subscriber ID and/or account code of the subscriber. Based on the billing information, the SCP identifies a subscriber account and associated account balance of the subscriber; and based on the service type and/or content, the SCP determines a cost of the service. The SCP determines an eligibility of the subscriber account to be billed for the service. In response to a positive determination, the SCP debits the cost of the service from the account balance and sends an acknowledgement to the gateway device; and the gateway device sends an acknowledgment to the service provider.

In one embodiment, there is provided a method for an entity (e.g., SCP) of an e-commerce system to determine the cost of a service based on at least one of a service type and content of the service. The SCP maintains a record (“tariff table”) including rate information corresponding to one or more services. The rate information may include content-based rates (based, for example, on number or size of messages) and/or flat rate charges. Upon receiving a rated debit request associated with a particular service of a certain service type and/or content, the SCP consults the record to determine the rate information corresponding to the service type and/or content and computes the cost of the service based on the rate information.

### BRIEF DESCRIPTION OF THE DRAWINGS

The foregoing and other advantages of the invention will become apparent upon reading the following detailed description and upon reference to the drawings in which:

FIG. 1 is a block diagram of an intelligent network-based e-commerce system that incorporates a gateway server according to one embodiment of the present invention;

FIG. 2 is a flowchart of a method for performing costing and billing of a rated transaction by a network-based e-commerce system of the type shown in FIG. 1;

FIG. 3 is a flowchart of a method for determining the cost of a service by a network-based e-commerce system of the type shown in FIG. 1;

FIG. 4 is a block diagram of an intelligent network-based e-commerce system incorporating a short message service center according one embodiment of the present invention;

FIG. 5 is a flowchart of a method for performing costing and billing of a short message service transaction by a network-based e-commerce system of the type shown in FIG. 4; and

FIG. 6 is a flowchart of a method for determining the cost of short message service by a network-based c-commerce system of the type shown in FIG. 4.

### DESCRIPTION OF THE PREFERRED EMBODIMENT(S)

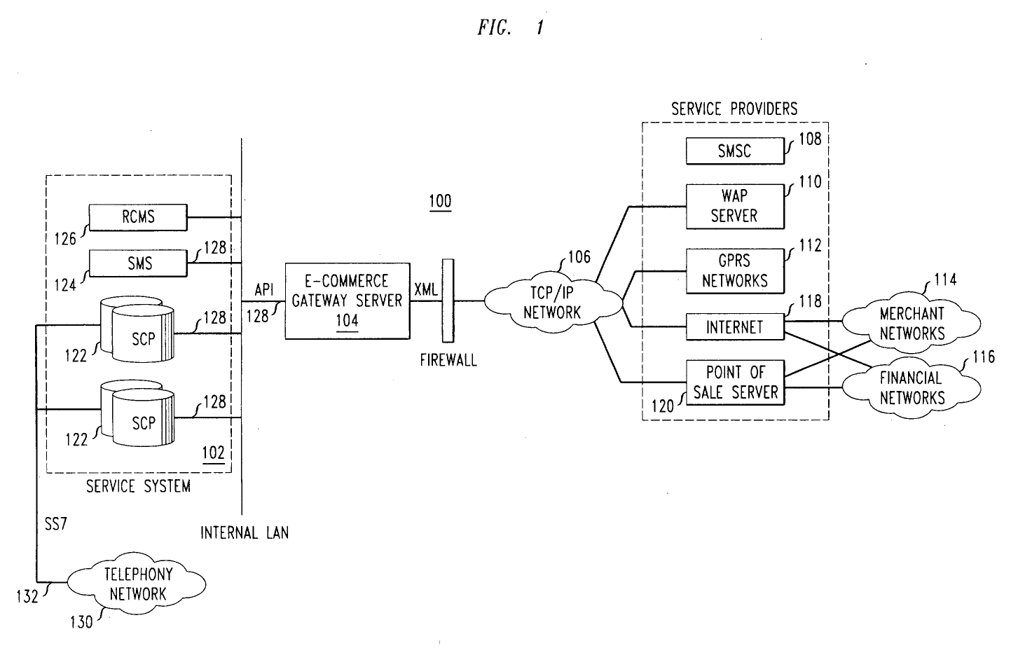

Turning now to the drawings and referring initially to FIG. 1, there is shown an intelligent network-based c-commerce system 100 according to one embodiment of the present invention. In one embodiment, the e-commerce system supports both prepaid and postpaid services.

The e-commerce system 100 comprises a service system 102 connected via a gateway server 104 to a packet network 106 (as shown, a TCP/IP network). The packet network 106 interfaces to various e-commerce merchants and/or services (hereinafter termed “service providers”) that may request access to the service system 102 to perform e-commerce transactions. As shown, the service providers include short message service center (“SMSC”) 108, Web Application Platform (WAP) server 110, General Packet Radio Service (GPRS) networks 112, merchant networks 114 and financial networks 116. As shown, the merchant and financial networks 114, 116 access the service system via the Internet 118 or “point of sale” servers 120. Subscribers of the e-commerce service (i.e., e-commerce customers) may also access the service system via the Internet 118 or point of sale servers 120.

As will be appreciated, the service providers shown in the e-commerce system 100 do not represent an exhaustive list but generally depict a wide range of e-commerce options available to prepaid or postpaid customers. The types of services that may be available from the service providers include, for example but not limitation, purchases of goods, movie tickets, telephony services, short message service, WAP service, Internet usage, Internet gaming and music or file uploads/downloads. The customer interacts with the service provider with communication devices (not shown) including but not limited to mobile phones, wireless hand-held devices, kiosks, point-of-service clients, Internet screens, etc.

The service system 102 comprises a plurality of Service Control Points (“SCPs”) 122, a service manager system (“SMS”) 124 and a recharge card management system (“RCMS”) 126. Each of these devices includes respective processors and memory (not shown) for effecting certain transactions relating to the services and capabilities of the service system 102. As will be described in greater detail later in this document, transactions supported by the service system 102 include determining charges for and debiting subscriber accounts for service(s) including but not limited to, real-time WAP services (both connection and content charging), GPRS services, SMSC charges (through gateway server), data services charge and Internet charges upon request from service providers.

The SCPs 122 maintain subscriber accounts and serve in the role of a “portal” to subscriber balance(s), thereby enabling service providers to access and modify subscriber account(s) in the course of e-commerce transactions. In one embodiment, a mated pair of SCPs is provided for purposes of redundancy; wherein for each subscriber, there is a designated “primary” SCP and “secondary” SCP.

The SCPs are connected to the gateway server 104 via links 128 (as shown, Application Programmable Interface (API) link(s)). One example of API link is Lightweight Directory Access Protocol (LDAP) developed by Lucent Technologies. The SCPs 122 are further connected to a telephony network 130 via links 132 (as shown, SS7 telephony signaling links) such that the service system 102 may support prepaid voice service for users of the telephony network 130 in addition to prepaid and/or postpaid services provided by the network-based service providers 108-120. The telephony network 130 may comprise a wired or wireline network using SS7 links.

The SMS 124 performs provisioning, administration and management functions for the service system 102. Generally, this includes generating and/or maintaining subscriber and service information associated with the service system 102 and downloading the information as required to the SCPs 122. The SMS 124 communicates with the SCPs via an API link 128 or TCP/IP interface (not shown) (e.g., CORBA over TCP/IP). More specifically, duties of the SMS 124 include: establishing new subscriber accounts and/or maintaining existing accounts (including subscriber IDs, credit amounts); mapping subscriber IDs to primary/secondary SCPs; identifying various attributes of the subscribers (for example, age, sex, language type, currency type, usage data, service preferences and/or restrictions); and generating comprehensive reports of account/usage information.

The RCMS 126 facilitates periodic recharging or replenishing of the subscriber accounts and communicating the recharging information as required to the SMS 124. The RCMS 124 communicates with the SMS 124 via an API link 128 or TCP/IP interface (not shown). The functions of the RCMS 126 are described in greater detail in related application Bartter 2-21-3-2-2-2, titled “Subscriber Account Replenishment in a Network-Based Electronic Commerce System Incorporating Prepaid Service Offerings.”

The gateway server 104 serves as an interface for service providers and/or subscribers to access the service system 102 (and hence, to access subscriber accounts) to facilitate e-commerce transactions. The gateway server 104 is a functional element that may reside in one or more physical devices. As shown, all network-based service providers 108-120 access the gateway server via the TCP/IP network 106, whereas the telephony network 130 may access the service system 102 directly, using SS7 protocol. The TCP/IP network 106 is adapted for transporting IP messages (or “datagrams”) via one or more routers (not shown). As will be appreciated, alternative configurations are possible. For example, certain service providers 108-120 may interface directly to the gateway server 104 (i.e., via links/networks other than the TCP/IP network 106).

In one embodiment, messages are communicated between the gateway server and service providers 108-120 and/or subscribers using eXtensible Markup Language (XML). XML is the universal format for structured documents and data on the Web. The XML protocol thus gives service providers and subscribers a great deal of flexibility to access the subscriber account information. For example, service providers or subscribers may access the account information from Internet screens, point-of-sale computing devices, wireless devices or generally any device that is capable of communicating with the gateway server 104 via XML protocol. As will be appreciated, protocols other than XML could be used.

In one embodiment, the gateway server 104 performs three primary functions: protocol conversion for e-commerce operations, subscriber mapping to the SCP(s) and operations logging. The protocol conversion function comprises translating XML queries or transaction requests from service providers or subscribers into the API format supported by the service system 102; and conversely, translating API responses of the service system 102 to XML format for delivery to service providers 108-120 or subscribers. The mapping function comprises maintaining a database identifying the primary and secondary SCP for each subscriber for which an e-commerce transaction has been performed. For subscribers who are first-time users of the e-commerce system, the gateway server queries the SMS 124 to identify the primary and secondary SCP and thereafter maintains the information in a mapping table/database. Thereafter, upon receiving a query or transaction relating to a particular subscriber, the gateway server consults the mapping table to determine the primary and secondary SCP (hence, freeing the service provider and subscribers from such burden). Optionally, the gateway server may periodically delete mappings of subscribers who are inactive for a period of time. Moreover, the gateway server may periodically re-identify primary and secondary SCPs if/when failures occur in the originally identified primary or secondary SCPs. In one embodiment, if there is an automatic provisioning of new entries of subscribers on the gateway server via SMS (i.e, SMS automatically provisions new subscribers in the mapping table at the gateway), the gateway will return error message to the client systems when receiving an unrecognized subscriber ID in incoming requests. The logging function logs all requests and indicates the outcome (i.e., success or failure) of each request.

In one embodiment, the gateway server includes processor and memory (not shown) operable to support a subscriber base of one million customers. This performance level can be scaled/tuned depending on the scope of the e-commerce system 100.

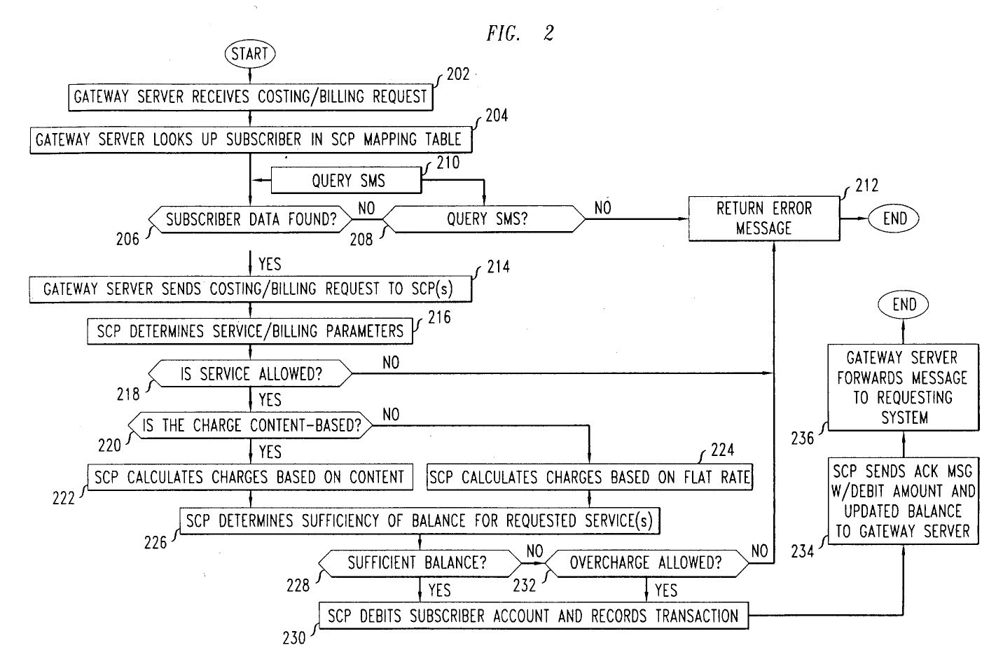

Turning to FIG. 2, there is shown a flowchart illustrating a rated debit request operation according to one embodiment of the present invention. Generally, this operation is used by a service provider to request costing and billing of a particular service not having a specific predefined cost. For example, the cost of the service may be based on service type and/or content type, number and/or size of messages, periodic type and subscription charges, etc.

At step 202, the gateway server 104 receives a costing/billing request. The request may be received, for example, from any of the network-based service providers 108-120 who, having received a request from an end user for a particular service, are contemplating charging the end user for the service via an e-commerce transaction. In one embodiment, the request includes a subscriber ID and account code, service type or content, number or size of messages or any other information relevant to determining the cost of the service. In one embodiment, the request is an XML-protocol message.

In response to the request, at step 204, the gateway server 104 consults its mapping table to determine whether subscriber data is found corresponding to the subscriber ID and/or account code identified in the request. In one embodiment, this subscriber data includes an identification of primary or secondary SCP(s) assigned to the subscriber account. As will be appreciated, different service providers may have different ID(s) or account codes for the same subscriber depending on the different service providers naming/numbering schemes. For example, for a mobile wireless service provider, the subscriber ID could be a Mobile Station International Subscriber Directory Number (MSISDN) or Mobile Directory Number (MDN) depending on the service provider's network. In one embodiment, the mapping table includes a mapping of multiple ID(s) to individual subscriber(s), where applicable, to accommodate different subscriber ID(s)/account codes.

If subscriber data is not found, determined at step 206, the gateway server optionally queries the SMS, determined at step 208, to determine whether the SMS 124 can identify a primary and/or secondary SCP corresponding to the subscriber ID. In response to a positive determination at step 208, the gateway server queries the SMS at step 210. In one embodiment, for example, the mapping table of the gateway server does not identify primary or secondary SCPs for first-time users. In such case, the gateway server may query the SMS to identify the primary and secondary SCP for the first-time user. The gateway server thereafter maintains the information in its mapping table.

If subscriber data is still not found after querying the SMS, or if the gateway server determines not to query the SMS at step 208, the gateway server returns an error message to the requesting system at step 212. Otherwise, if subscriber data is found (i.e., the gateway server identifies the primary and/or secondary SCP corresponding to the subscriber ID), the gateway server sends at step 214 a cost/billing request message to the designated SCP(s). In one embodiment, this comprises sending the subscriber ID, account code, transaction ID, message type (i.e., rated debit request), number of messages, service type, account type, account indicator in appropriate API format to the primary SCP and, if no response is received within a predetermined time, to the secondary SCP. Alternatively, as will be appreciated, the gateway server may send the cost/billing request simultaneously to the primary and secondary SCPs. For convenience, the term “SCP” will hereinafter be understood to refer to the acting SCP, whether it be the primary or secondary SCP.

At step 216, the SCP determines service/billing parameters associated with the service and customer. In one embodiment, this comprises determining whether the service is allowed (i.e., whether the subscriber is authorized or able to partake in the requested service) and whether the charge for the service is content-based or based on a flat rate. If the service is not allowed, determined at decision block 218, the SCP returns an error message to the gateway server at step 212. For example, short message service may not be allowed when an end user is engaged in a call. In such case, the SCP will return an error message to the gateway server 212.

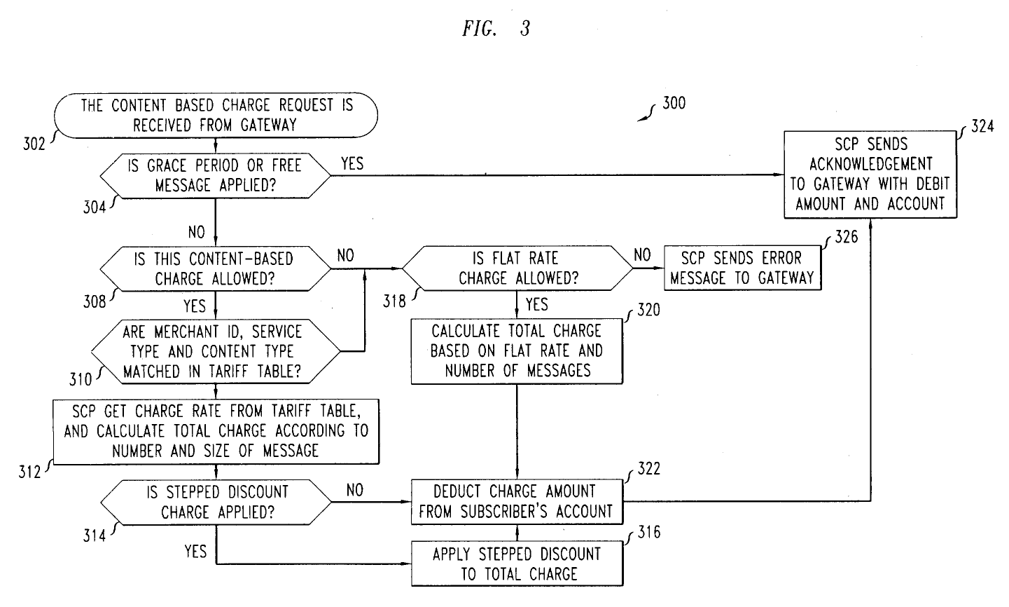

If the service is content-based, determined at decision block 220, the SCP calculates charges for the service based on content at step 222. If the service is not content-based, the SCP calculates charges based on a flat rate at step 224. In one embodiment, the SCP maintains a tariff table identifying rates/charges for various services and calculates charges based on the tariff table. For example, the SCP may determine a charge rate based on service type or content type as identified in the tariff table, and calculate the total charge amount based on the service type and/or content type, number of messages, subscription charge, grace period and/or discounts. One manner of determining charges based on a tariff table is described in relation to FIG. 3.

At step 226, after having computed charges for the requested service, the SCP determines the sufficiency of the subscriber balance to accommodate the requested purchase (or whether the balance exceeds minimum balance thresholds, if applicable). If there is an insufficient balance, determined at decision block 228, the SCP determines at decision block 232 whether overcharging (i.e., delivering services having a value greater than the subscriber balance) is permitted. If not, the SCP returns an error message indicating insufficient balance to the gateway server at step 212. Conversely, if there is a sufficient balance or if there is an insufficient balance but overcharging is permitted (and e-commerce is enabled), the SCP debits the subscriber account and records the transaction into a Call Detail Record (CDR) at step 230. Then, at step 234, the SCP sends an acknowledgment message to the gateway server with the debit amount and updated account balance. The gateway server forwards the acknowledgment message to the requesting system at step 236 after appropriate conversion from API to XML format.

FIG. 3 is a flowchart of a method for determining the cost of a service based on type and/or content by an intelligent network-based e-commerce system according to one embodiment of the invention. The service types may comprise, for example, WAP, GPRS or UMTS message usage, SMSC (originating or terminating), etc. The content may comprise, for example, news, e-mail, sports information, stock quotes, weather updates, etc. The steps of FIG. 3 are implemented, where applicable, using stored software routines within one or more SCPs 122 of the e-commerce system. In one embodiment, the SCPs maintain a tariff table to assist in performing the steps of FIG. 3.

At step 302, the SCP 122 receives a charge request from the gateway server 104. At step 304, the SCP determines whether a grace period or free message(s) is applicable. A grace period is an option whereby service providers may provide free service to customers for a period of time (e.g., for 30 days after signing up for the service). Free messages are another option whereby the service providers may provide free service for a period of time (e.g., first 100 messages free after signing up for the service). In one embodiment, indicators for start and stop times of a grace period or number of free messages is present (or not) in the tariff table, as applicable. The SCP consults the tariff table to determine whether a grace period or free message is applicable at step 304. If a grace period or free message applies, there will be no charge for the service. The SCP sends at step 324 an acknowledgment to the gateway server 104 with debit amount (i.e., zero) and the account balance.

If the grace period or free message does not apply, the SCP determines at step 308 if a content-based charge is allowed for the particular subscriber and service. For example, depending on service provider contracts and the like, certain subscribers may elect flat rate charges rather than content-based charges, or vice versa. In one embodiment, indicators of whether content-based or flat rate charges are to be used are maintained in the tariff table. The SCP consults the tariff table at step 308 as appropriate. If content-based charges are not allowed, the SCP determines at step 318 if a flat rate charge is allowed. If neither content-based or flat rate charges are allowed, the SCP sends at step 326 an error message to the gateway server 104.

If content-based charges are allowed, the SCP determines at step 310 if the merchant ID, service type and content type are matched in the tariff table. That is, the SCP determines if the tariff table has an entry or entries matching the merchant ID to a service type and content type. If not, the SCP does not charge based on content and, at step 318, the SCP determines whether a flat rate charge is allowed. If the flat rate charge is not allowed, the SCP sends at step 326 an error message to the gateway server 104. If flat rate charge applies, the SCP calculates the total charge at step 320 based on the flat rate and number of messages.

If content-based charges are allowed and the tariff table has appropriate entries, the SCP at step 312 retrieves a charge rate associated with the content from the tariff table and calculates a total charge. In one embodiment, the SCP computes the total charge by multiplying the rate associated with the content type by the number of messages of that content type. For example, one possible content-based charging scenario is as follows: the SCP receives a charge request from the gateway server for service type: short message service (originating); content type: sports scores; and number of messages=3; the SCP consults the tariff table to determine the charge rate (e.g., $0.20 per message) for the service type and content; and the SCP multiplies the charge rate times the number of messages to compute the total charge (e.g., $0.60).

At step 314, the SCP determines if stepped discount charging applies. A stepped discount is an option whereby service providers may offer discounts after certain periods or degree of use. For example, customers might be charged a full rate (i.e., 100%) for the first 100 messages, 80% rate for the second 100 messages, 50% rate for the third 100 messages, and so forth. Alternatively, discounts may be loaded more heavily at the beginning, for example: 50% for the first 100 messages, 80% rate for the second 100 messages, 100% rate for the third 100 messages. As another example, stepped discounts could apply based on periods of time such as 100% rate during first month, 50% rate in second month, etc. If stepped discount charging applies, the SCP applies the stepped discount to the total charge at step 316.

Other options supported by the SCP(s) include subscription-based charging and simple per-message usage charging. Subscription-based charging is an option whereby subscribers are charged periodic subscription fees in addition to or in lieu of content-based or flat rate charges. Per message charging is an option whereby subscribers are charged variable or flat rates based on numbers of messages regardless of content. At step 322, the SCP deducts the charge amount (however computed) from the subscriber account. At step 324, the SCP sends an acknowledgment message to the gateway server with the debit amount and updated account balance.

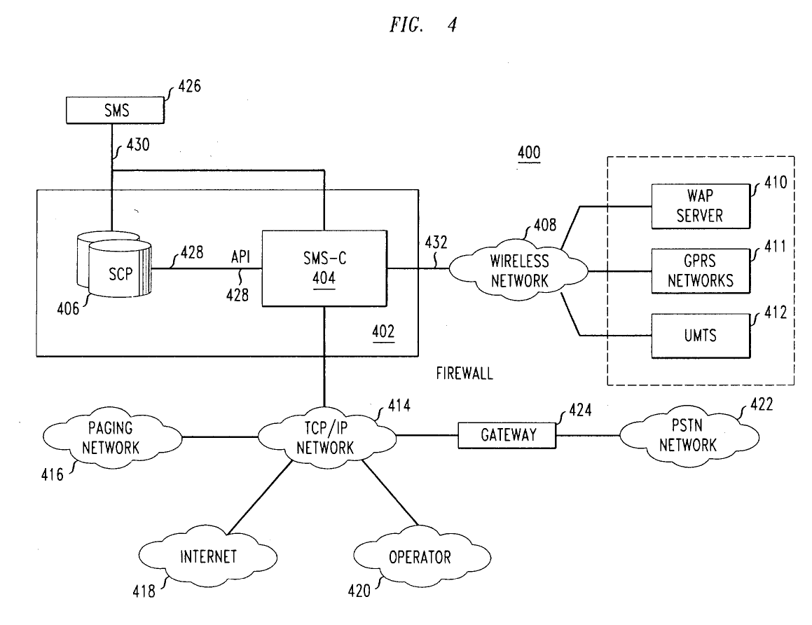

Turning now to FIG. 4, there is shown an intelligent network-based e-commerce system 400 providing short message service according to one embodiment of the present invention. Generally, the system 400 is an alternative to the system 100 of FIG. 1 that is particularly adapted for computing costs and billing for short message service and which does not rely on a gateway server. Rather, as will be described in greater detail hereinafter, the system of FIG. 4 relies upon a short message service center (“SMSC”) 404 as a gateway device.

In one embodiment, the system 400 supports both prepaid and postpaid services. Prepaid service defines a service where customers pay up front for a certain level of goods or services and, as long as sufficient balance is present in their account, may perform e-commerce transactions without the need for credit cards or contracts and without receiving monthly bills. Prepaid services offerings are known for voice telecommunications but to date have not been available for e-commerce transactions. Postpaid service defines the conventional form of transaction where a customer orders goods or services, typically using a credit card, and pays the credit card company some time later.

The e-commerce system 400 comprises a service system 402 comprising a short message service center (“SMSC”) 404 and one or more Service Control Points (“SCPs”) 406. Each of these devices includes respective processors and memory (not shown) for effecting short message service e-commerce transactions. As will be described in greater detail later in this document, transactions supported by the service system 402 include determining charges for and debiting subscriber accounts for short message service(s) upon request from service providers.

The SMSC 404 is linked to various services/providers via one or more networks. As shown, the networks include a wireless network 408 that interfaces to Web Application Platform (WAP) server 410, General Packet Radio Service (GPRS) networks 411 and Universal Mobile Telecommunications System (UMTS) networks 412; and a TCP/IP network (more generally, “packet network”) 414 that interfaces to entities including a paging network 416, the Internet 418, operator bureau 420 and the Public Switched Telephone Network (PSTN) 422. The operator bureau is an entity including one or more operators that is operable to broadcast short messages to all end users, or a subset of end users, as may be requested by service providers for advertisements, etc. The PSTN 422 is connected to the packet network 414 via a telephony gateway 424. Subscribers of the e-commerce service (i.e., e-commerce customers) may also access the service system, for example, via the Internet 418.

The SMSC 404 provides the ability for subscribers to send and receive short text messages using wireless device(s) (not shown). In one embodiment, the basic applications of the SMSC 404 include voice and fax mail notification, inbound digital paging, web-based messaging, e-mail connectivity, operator bureau connectivity, desktop messaging support, information services, mobile-originated text messaging, mobile-originated e-mail and broadcast messaging. In one embodiment, the SMSC comprises a Wireless Intelligent Network (WIN) SMSC available from Lucent Technologies. The WIN SMSC is described in detail in “Short Message Service Center (SMSC)—Product Description v5.1G, dated Dec. 4, 2000, incorporated herein by reference.

The SMSC 404 serves as an interface for short message service providers to access the service system 402 (and hence, to access subscriber accounts) via link(s) 432 to facilitate e-commerce transactions. The SMSC 404 is a functional element that may reside in one or more physical devices. In one embodiment, the interface from client applications to the SMSC 404 has two different paths: 1) wireless (voice) devices (such as cell phones) interface to Mobile Switching Center(s) (MSCs)/Base Stations through an air interface, and the MSC(s) interface with the SMSC via SS7 telephony signaling; (2) wireless or wireline clients (such as WAP, GPRS, UMTS) interface with the SMSC directly through API, such as LDAP or XML, over TCP/IP networks. As will be appreciated, other interface protocols could be used.

The SCPs 406 maintain subscriber accounts and serve in the role of a “portal” to subscriber balance(s), thereby enabling service providers to access and modify subscriber account(s) in the course of e-commerce transactions. In one embodiment, a mated pair of SCPs is provided for purposes of redundancy; wherein for each subscriber, there is a designated “primary” SCP and “secondary” SCP. The SCPs are connected to the SMSC 404 via link(s) 428 (as shown, Application Programmable Interface (API) link(s)). One example of API link is Lightweight Directory Access Protocol (LDAP) developed by Lucent Technologies.

The SCPs are connected via link(s) 430 to a service management system (SMS) 426. In one embodiment, the link(s) 430 comprise API links. The SMS 426 performs provisioning, administration and management functions for the service system 402. Generally, this includes generating and/or maintaining subscriber and service information associated with the service system 402 and downloading the information as required to the SCPs 406. More specifically, duties of the SMS 426 include: establishing new subscriber accounts and/or maintaining existing accounts (including subscriber IDs, credit amounts); mapping subscriber IDs to primary/secondary SCPs; identifying various attributes of the subscribers (for example, age, sex, language type, currency type, usage data, service preferences and/or restrictions); and generating comprehensive reports of account/usage information.

In one embodiment, the SMSC 404 performs subscriber mapping to the SCP(s) and operations logging. The mapping function comprises maintaining a database identifying the primary and secondary SCP for each subscriber for which an e-commerce transaction has been performed. For subscribers who are first-time users of the e-commerce system, the SMSC 404 queries the SMS 426 to identify the primary and secondary SCP and thereafter maintains the information in a mapping table/database. Thereafter, upon receiving a query or transaction relating to a particular subscriber, the SMSC 404 consults the mapping table to determine the primary and secondary SCP (hence, freeing the service provider and subscribers from such burden). Optionally, the SMSC 404 may periodically delete mappings of subscribers who are inactive for a period of time. Moreover, the SMSC 404 may periodically re-identify primary and secondary SCPs if/when failures occur in the originally identified primary or secondary SCPs. The logging function logs all requests and indicates the outcome (i.e., success or failure) of each request.

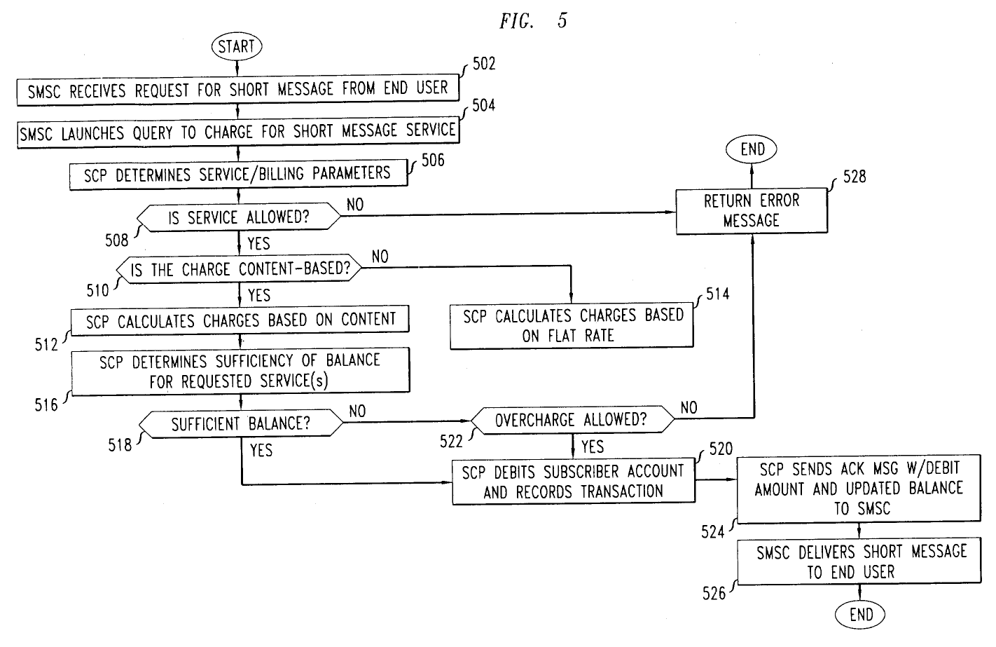

Turning to FIG. 5, there is shown a flowchart illustrating costing and billing of a short message service transaction according to one embodiment of the present invention.

At step 502, the SMSC 404 receives a request for short message service from an end user/subscriber. In one embodiment, the request includes a subscriber ID and account code associated with the subscriber. In response to the request, at step 504, the SMSC 404 launches a query directed to the designated SCP(s) assigned to the subscriber account to charge for short message service. In one embodiment, the query includes a subscriber ID and account code, service type or content, number or size of messages or any other information relevant to determining the cost of the service. It is presumed for purposes of example that the SMSC is able to successfully determine the designated SCP(s) prior to launching the query.

At step 506, the SCP determines service/billing parameters associated with the short message service and customer. In one embodiment, this comprises determining whether the service is allowed (i.e., whether the subscriber is authorized or able to partake in short message service) and whether the charge for the service is content-based or based on a flat rate. Historically, it is noted, charges for short message services have been based on flat rate. The present invention provides the flexibility for charging based on content or flat rate as desired by the service provider. Depending on parameters established by the service provider, charges might be levied for originating (i.e., sending) short messages, terminating (i.e., receiving) short messages or both originating and terminating short messages.

If the service is not allowed, determined at decision block 508, the SCP returns an error message to the SMSC at step 528. For example, an end user engaged in a call may not be allowed to receive short messages. In such case, the SCP will return an error message to the SMSC at step 528. Thereafter, in one embodiment, the SMSC denies the end users request with explanation and will not deliver the short message. Alternatively, the SMSC may deliver the short message in whole or in part even though receiving an error message.

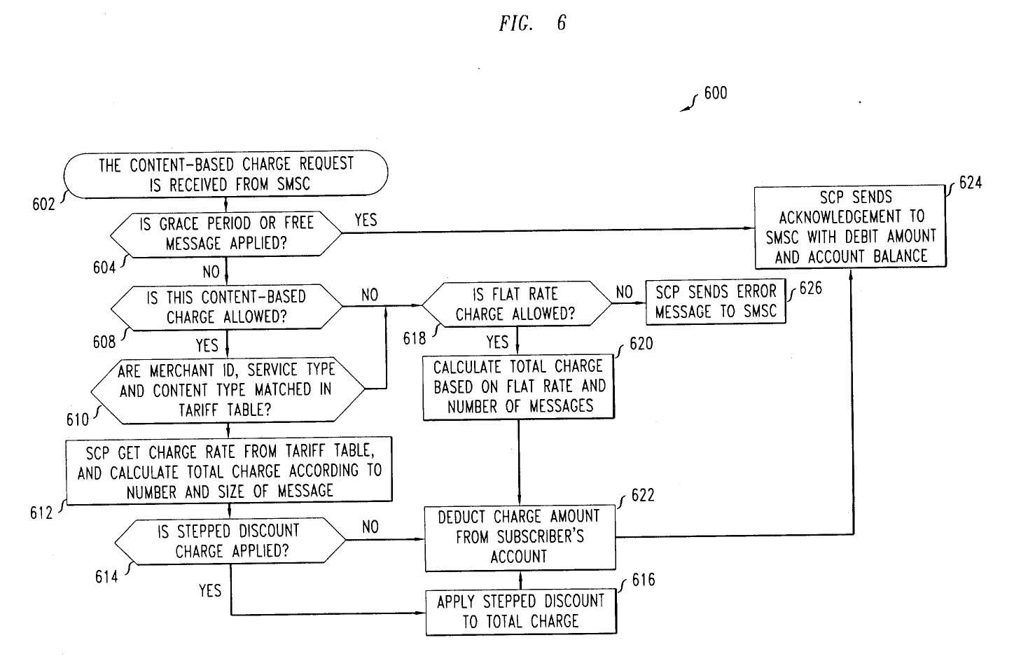

If the charge for the short message service is content-based, determined at decision block 510, the SCP calculates charges based on content at step 512. If the charge for the short message service is not content-based, the SCP calculates charges based on a flat rate at step 514. In one embodiment, the SCP maintains a tariff table identifying various rates/charges. The SCP is able to calculates charges from the tariff table according to service type, content type, number (or size, either in kilobytes or packets) of messages (i.e., packets) and charging rates. One manner of determining charges based on a tariff table is described in relation to FIG. 6.

At step 516, after having computed charges for the requested short message service, the SCP determines the sufficiency of the subscriber balance to accommodate the requested short message service (or whether the balance exceeds minimum balance thresholds, if applicable). If there is an insufficient balance, determined at decision block 518, the SCP determines at decision block 522 whether overcharging (i.e., delivering services having a value greater than the subscriber balance) is permitted. If not, the SCP returns an error message indicating insufficient balance to the SMSC at step 528. In one embodiment, responsive to receiving the error message, the SMSC denies the end users request with explanation and will not deliver the short message. Alternatively, the SMSC may deliver the short message in whole or in part even though receiving an error message.

If at step 518 there is a sufficient balance or if there is an insufficient balance but overcharging is permitted at step 522 (and e-commerce is enabled), the SCP debits the subscriber account and records the transaction into a Call Detail Record (CDR) at step 520. Then, at step 524, the SCP sends an acknowledgment message to the SMSC with the debit amount and updated account balance. The SMSC delivers the short message to the end user at step 526.

FIG. 6 is a flowchart of a method for determining the cost of a short message service based on content by an intelligent network-based e-commerce system according to one embodiment of the invention. The e-commerce system may charge for originating and/or terminating short message service. The content may comprise, for example, news, e-mail, sports information, stock quotes, weather updates, etc. The steps of FIG. 6 are implemented, where applicable, using stored software routines within one or more SCPs 406 of the e-commerce system. In one embodiment, the SCPs maintain a tariff table to assist in performing the steps of FIG. 6.

At step 602, the SCP 406 receives a charge request from the SMSC 404. At step 604, the SCP determines whether a grace period or free message(s) is applicable. A grace period is an option whereby service providers may provide free service to customers for a period of time (e.g., for 30 days after signing up for the service). Free messages are another option whereby the service providers may provide free service for a period of time (e.g., first 400 messages free after signing up for the service). Free messages might also apply for certain content/types of messages. For example, broadcast messages from an operator bureau may be provided to end users free of charge and indicated as such in the tariff table. In one embodiment, indicators for start and stop times of a grace period or number of free messages is present (or not) in the tariff table, as applicable. The SCP consults the tariff table to determine whether a grace period or free message is applicable at step 604. If a grace period or free message applies, there will be no charge for the service. The SCP sends at step 624 an acknowledgment to the SMSC 404 with debit amount (i.e., zero) and the account balance.

If the grace period or free message does not apply, the SCP determines at step 608 if a content-based charge is allowed for the particular subscriber and service. For example, depending on service provider contracts and the like, certain subscribers may elect flat rate charges rather than content-based charges, or vice versa. In one embodiment, indicators of whether content-based or flat rate charges are to be used are maintained in the tariff table. The SCP consults the tariff table at step 608 as appropriate. If content-based charges are not allowed, the SCP determines at step 618 if a flat rate charge is allowed. If neither content-based or flat rate charges are allowed, the SCP sends at step 626 an error message to the SMSC 404.

If content-based charges are allowed, the SCP determines at step 610 if the merchant ID, service type and content type are matched in the tariff table. That is, the SCP determines if the tariff table has an entry or entries matching the merchant ID to originating and/or terminating short message service and a content type. If not, the SCP does not charge based on content and, at step 618, the SCP determines whether a flat rate charge is allowed. If the flat rate charge is not allowed, the SCP sends at step 626 an error message to the SMSC 404. If flat rate charge applies, the SCP calculates the total charge at step 620 based on the flat rate and number of messages.

If content-based charges are allowed and the tariff table has appropriate entries matching the merchant ID to content type(s), the SCP at step 612 retrieves a charge rate associated with the content from the tariff table and calculates a total charge. In one embodiment, the SCP computes the total charge by multiplying the rate associated with the content type by the number of messages of that content type. For example, one possible content-based charging scenario is as follows: the SCP receives a charge request from the SMSC for short message service (originating), content type: sports scores; and number of messages=3; the SCP consults the tariff table to determine the charge rate (e.g., $0.20 per message) for the content; and the SCP multiplies the charge rate times the number of messages to compute the total charge (e.g., $0.60).

At step 614, the SCP determines if stepped discount charging applies. A stepped discount is an option whereby service providers may offer discounts after certain periods or degree of use. For example, customers might be charged a full rate (i.e., 100%) for the first 100 messages, 80% rate for the second 100 messages, 50% rate for the third 100 messages, and so forth. Alternatively, discounts may be loaded more heavily at the beginning, for example: 50% for the first 100 messages, 80% rate for the second 100 messages, 100% rate for the third 100 messages. As another example, stepped discounts could apply based on periods of time such as 100% rate during first month, 50% rate in second month, etc. If stepped discount charging applies, the SCP applies the stepped discount to the total charge at step 616.

Other options supported by the SCP(s) include subscription-based charging and simple per-message usage charging. Subscription-based charging is an option whereby subscribers are charged periodic subscription fees in addition to or in lieu of content-based or flat rate charges. Per message charging is an option whereby subscribers are charged variable or flat rates based on numbers of messages regardless of content. At step 622, the SCP deducts the charge amount (however computed) from the subscriber account. At step 624, the SCP sends an acknowledgment message to the SMSC with the debit amount and updated account balance.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. In an electronic commerce system maintaining a plurality of subscriber accounts for one or more subscribers, a method comprising:
receiving, from a service provider, a rated debit request, the rated debit request including an identifier of a subscriber to be charged for a service, and indicia of at least one of a service type and content associated with the service;
identifying a subscriber account and associated account balance corresponding to the identifier;
determining, based on at least one of the service type and content of the service, a cost of the service;
determining an eligibility of the subscriber account to be billed for the service; and
if the subscriber account is eligible to be billed for the service, debiting the cost of the service from the account balance, yielding an updated account balance; and sending an acknowledgment message to the service provider.

2. The method of claim 1, wherein the step of determining an eligibility of the subscriber account to be billed for the service comprises determining an enablement status of the account to receive the service.

3. The method of claim 1, wherein the step of determining an eligibility of the subscriber account to be billed for the service comprises determining a sufficiency of the account balance to accommodate the cost of the service.

4. The method of claim 3, wherein the step of determining an eligibility of the subscriber account to be billed for the service comprises:
determining a sufficiency of the account balance to accommodate the cost of the service; and
if the account balance is insufficient to accommodate the cost of the service, determining an eligibility of the subscriber account to accept overcharges.

5. The method of claim 1, comprising:
if the subscriber account is ineligible to be billed for the service, sending a negative acknowledgment message to the service provider.

6. In an electronic commerce system containing one or more service control points (SCPs) operably connected to a gateway device, the SCPs maintaining subscriber accounts for one or more subscribers and maintaining cost information associated with one or more services, a method comprising:
receiving, by the gateway device from a service provider, a rated debit request, the rated debit request including an identifier of a subscriber to be charged for a service, and indicia of at least one of a service type and content associated with the service;
sending, from the gateway device to an SCP of the one or more SCPs, a message including billing information associated with the rated debit request, the billing information comprising at least one of a subscriber ID and account code of the subscriber;
identifying, by the SCP based on the billing information, a subscriber account and associated account balance of the subscriber;
determining, by the SCP based on at least one of the service type and content of the service, a cost of the service;
determining, by the SCP, an eligibility of the subscriber account to be billed for the service;
if the subscriber account is eligible to be billed for the service,
debiting, by the SCP, the cost of the service from the account balance, yielding an updated account balance;
sending an acknowledgment message from the SCP to the gateway device; and
sending an acknowledgement message from the gateway device to the service provider.

7. The method of claim 6, wherein the step of determining an eligibility of the subscriber account to be billed for the service comprises determining, by the SCP, an enablement status of the account to receive the service.

8. The method of claim 6, wherein the step of determining an eligibility of the subscriber account to be billed for the service comprises determining, by the SCP, a sufficiency of the account balance to accommodate the cost of the service.

9. The method of claim 8, wherein the step of determining an eligibility of the subscriber account to be billed for the service comprises:
determining, by the SCP, a sufficiency of the account balance to accommodate the cost of the service; and
if the account balance is insufficient to accommodate the cost of the service, determining, by the SCP, an eligibility of the subscriber account to accept overcharges.

10. The method of claim 6, comprising:
if the subscriber account is ineligible to be billed for the service, sending a negative acknowledgment message from the SCP to the gateway device; and sending a negative acknowledgment message from the gateway device to the service provider.

11. The method of claim 6, wherein the gateway device comprises a gateway server.

12. The method of claim 6, wherein the gateway device comprises a short message service center (SMSC).

13. In an electronic commerce system adapted to receive a rated debit request including indicia of at least one of a service type and content associated with a particular service, a method of determining a cost of the service, the method comprising:
maintaining a record including rate information corresponding to one or more services;
consulting the record to determine the rate information corresponding to the at least one of the service type and content identified in the rated debit request; and
computing the cost of the service based on the rate information.

14. The method of claim 13, wherein the rate information includes one or more content-based rates.

15. The method of claim 14, wherein the content-based rates are selected from the group consisting of: price per unit quantity of messages, price per unit quantity of packets, price per unit size of messages and price per unit size of packets.

16. The method of claim 13, wherein the rate information includes one or more flat rates.

17. The method of claim 13, wherein the rate information includes indicia of grace period applicability to the cost of the service.

18. The method of claim 13, wherein the rate information includes indicia of free message applicability to the cost of the service.

19. The method of claim 13, wherein the rate information includes indicia of stepped discount applicability to the cost of the service.

20. In an electronic commerce system containing one or more service control points (SCPs) operably connected to a gateway device, the SCPs maintaining a record including rate information corresponding to one or more services, a method of determining a cost of a service comprising:
receiving, by the gateway device, a rated debit request including indicia of at least one of a service type and content associated with a particular service;
sending, from the gateway device to an SCP of the one or more SCPs, a message including at least one of the service type and content identified in the rated debit request;
consulting, by the SCP, the record to determine the rate information corresponding to the at least one of the service type and content identified in the rated debit request; and
computing, by the SCP, the cost of the service based on the rate information.

21. The method of claim 20, wherein the gateway device comprises a gateway server.

22. The method of claim 20, wherein the gateway device comprises a short message service center (SMSC).
